(19) United States
(12) Patent Application Publication
(10) Pub. No.: US 2025/0388991 A1
(43) Pub. Date: Dec. 25, 2025

(54) HIGH-SPEED JET AND RADIATION COMBINED HEATING DEVICE AND RAPID HEATING METHOD THEREOF

(71) Applicant: BAOSHAN IRON & STEEL CO., LTD., Shanghai (CN)

(72) Inventors: Lixiang ZHANG, Shanghai (CN); Jun LI, Shanghai (CN); Liyang ZHANG, Shanghai (CN); Yimin LIU, Shanghai (CN); Jian WANG, Shanghai (CN)

(73) Assignee: BAOSHAN IRON & STEEL CO., LTD., Shanghai (CN)

(21) Appl. No.: 19/110,180

(22) PCT Filed: Sep. 15, 2023
(86) PCT No.: PCT/CN2023/119092

§ 371 Date: Mar. 12, 2025

(30) Foreign Application Priority Data
Sep. 15, 2022 (CN) 202211122789.9

(51) Int. Cl. C21D 9/56; C21D 1/34; F27D 17/13

(52) U.S. Cl. CPC C21D 9/562; C21D 1/34; F27D 17/13

(57) ABSTRACT

A high-speed jet and radiation combined heating device and a rapid heating method thereof. The device comprises: a heat-preservation box body (1) a circulating fan (2); a buffering chamber (3); two jet bellows (4); a plurality of rows of jet high-speed nozzles (5); and a plurality of radiation tubes (6). A high-speed jet heating technology and a radiation tube (6) heating technology are combined to achieve a high heating rate, and to bring the advantages of good heating uniformity and so on of high-speed jet heating into full play, thus greatly accelerating the heating rate and improving the heat efficiency of steel strip.

### CROSS-REFERENCE TO RELATED APPLICATIONS

This application is a 371 U.S. National Phase of PCT International Application No. PCT/CN2023/119092 filed on Sep. 15, 2023, which claims benefit and priority to Chinese patent application No. CN202211122789.9 filed on Sep. 15, 2022, the contents of each of above-referenced application are incorporated by reference herein in their entiries.

### TECHNICAL FIELD

The present invention relates to the field of continuous heat treatment, specifically to a high-speed jet and radiation combined heating device and rapid heating method thereof.

### BACKGROUND ART

Currently, large-scale continuous annealing furnaces, hot-dip galvanizing annealing furnaces, and protective atmosphere heating furnaces for cold-rolled steel strip production in China primarily adopt radiation tube heating. This method relies on radiation heating and natural convection of protective gases within the furnace. While radiation tube heating offers advantages such as clean combustion inside the tubes, high surface quality of steel strips, and low furnace failure rates, its drawbacks include slow heating rate. According to furnace heating models:

$$ρ {vc}_{p} \frac{\partial T}{\partial τ} = A εσ ( {T}_{0}^{4} - {T}^{4} ) + Ah ( {T}_{0} - T ) \qquad ( 1 )$$

$$h - 9.2 \sqrt[4]{( {T}_{0} - T )} \qquad ( 2 )$$

For a 1 mm-thick steel strip at 100° C., the heating rate is approximately 12° C./s. As the strip temperature rises, the heating rate gradually decreases, dropping to around 1° C./s at 800° C. Due to the low heating rate, extended furnace heating sections result in significant heat loss through the furnace casing, leading to low thermal efficiency (approximately 50%). Additionally, non-uniform temperature distribution in radiation tubes (local temperature difference ˜150° C.) causes uneven strip heating during annealing, leading to defects like C-warping and hindering stable strip passage.

To address these issues, the international community has successfully developed and industrially implemented dual-P-type radiation tubes which have achieved a temperature difference across the tube body of approximately 50° C., enhancing product quality and production efficiency. Furthermore, these tubes feature lower flue gas emission temperatures, higher exhaust gas recirculation efficiency, and preheated combustion air temperatures reaching 700° C., thereby further improving overall thermal efficiency. However, these advancements still fail to resolve core challenges such as the slow heating rate of steel strips and the high thermal inertia of the furnace, which continue to hinder the development of continuous annealing and hot-dip galvanizing units toward higher efficiency and productivity.

Jet heating technology, where fluid is impinged onto solid surfaces via nozzles, offers enhanced heat transfer. Impact jet flows exhibit short flow paths and thin boundary layers, achieving convective heat transfer coefficients a plurality of times to an order of magnitude higher than conventional methods. Unlike radiant heating, jet heating is unaffected by material emissivity, making it prevalent in low-emissivity applications (e.g., non-ferrous metals, as in European Patent EP1507013A1).

The annealing of aluminum materials requires stringent temperature control, such as maintaining a widthwise temperature difference of 3-5° C. across the aluminum strip and limiting the maximum annealing temperature to 600° C. To meet these requirements, jet heating technology is employed in industrial production. The temperature of the heating gas is typically controlled at 600° C. to prevent strip breakage caused by unexpected shutdowns. Key advantages of this heating process include: Uniform widthwise heating of the aluminum strip while ensuring the peak temperature does not exceed 600° C., enabling stable and continuous production. Rapid heating rates facilitated by jet heating technology, significantly reducing the required length of the production line.

### SUMMARY

The invention aims to provide a high-speed jet and radiation combined rapid heating method that integrates high-speed jet heating technology and radiation tube heating technology. This approach not only achieves fast heating rate but also leverages the high-speed jet's uniform heating and rapid heat transfer while enhancing thermal efficiency, reducing environmental impact of the furnace. It holds significant importance for advancing China's continuous annealing furnace technology and developing low-carbon solutions.

In order to achieve the above objectives, the technical solution of the present application comprises:
a high-speed jet and radiation combined heating device, comprising:
a heat-preservation box body, a mounting hole being formed in the center of one side thereof;
a circulating fan, arranged at the mounting hole of the heat-preservation box body, with its air inlet corresponding to the axis of the mounting hole, and its air outlet provided on the side of the casing;
a buffering chamber, arranged in the heat-preservation box body at a position corresponding to the air inlet of the circulating fan, the back side of the buffer chamber is provided with a hot air outlet corresponding to the air inlet of the circulating fan, and a hot air inlet being formed in the front side of the buffering chamber;
two jet bellows, vertically and symmetrically arranged on the two sides of the hot air inlet at the front side of the buffering chamber in the heat-preservation box body, forming a passage for steel strip traversal; on one side of the two jet bellows located on both sides of the passage, a plurality of rows of nozzles are spaced along the height direction, with a gap provided between every n rows of nozzles, wherein n≥1;
a plurality of radiation tubes, symmetrically arranged in the two jet bellows, each comprising a connection tube section connects to the nozzles, a radiation tube section bends and extends from one end of the connection tube section, and a heat exchange tube section formed by bending and extending from one end of the radiation tube section, the radiation tube section corresponding to the gap between n rows of high-speed jet nozzles in the jet bellows, forming an alternating jet-and-radiation structure.

Preferably, the jet bellows are high-temperature jet bellows. Preferably, the temperature of the high-temperature gas in high-temperature jet bellows is 750° C. or higher, such as 750-880° C.

Preferably, the buffering chamber and jet bellows are of an integrated structure.

Preferably, the nozzles are of circular hole structure, to ensure that the nozzles is not prone to deformation under high temperatures, to reduce the vibrations that can be caused in the steel strip.

Preferably, the diameter of the nozzles is 1/10 to ⅕ of the distance between the nozzles and the steel strip; within this range, the convective heat transfer coefficient of the jet remains stable, exceeding this range causes the convective heat transfer coefficient decreases significantly.

Preferably, the nozzles are high-speed jet nozzles. Preferably, the velocity of the jet gas at the nozzles outlet of is not less than 50 m/s.

Preferably, the radiation tubes' radiation tube section, connection tube section, and heat exchange tube section are arranged in parallel. The radiation tubes have the function of both radiant heating of the steel strip and heat exchanger heating of the jet gas.

Preferably, the heat-preservation box body contains thermal insulation material within its casing.

The high-speed jet and radiation combined heating device and rapid heating method thereof adopted in the present invention, the radiation tubes is connected to the nozzles via the connection tube section, combustion gases within the radiation tube fully burn, radiant heating to the steel strip entering the passage through the radiation tube section; simultaneously, the heat exchange tube section heats the gas pressurized by the circulating fan and entering the heat-preservation box body, the heated air enter the jet bellows, heating the steel strip through the high-speed jet nozzles jet, wherein the hot air after heated the steel strip, after being pressurized by the circulating fan, re-enters the heat-preservation box body through the air outlet of the circulating fan, and is heated by the heat exchange tube section of the radiation tubes, thereby completing the cycle.

Preferably, the gas for jetting the steel strip is N₂+H₂.

In the present invention, the hot air is heated within the jet bellows equipped with radiation tubes. The radiation tubes serve dual functions: heating and heat exchange. To enhance heat transfer between the hot air and radiation tubes, at the same time take into account the resistance loss of the hot air in the jet bellows, the radiation tubes are designed with a spatial structure. One passage faces the steel strip for radiant heating, while other passages heat the hot air. The heat of the radiation tubes is generated via nozzles combustion.

The jet and radiation combined heating technology of the present invention produces hot air in the heat-preservation box body equipped with radiation tubes. The gas after heating the steel strip through the high-speed jet is returned to the heat-preservation box body through the circulating fan to be heated again, completing the cycle. Simultaneously, the radiation tube section of the radiation tube directly faces the steel strip for radiant heating. And because the radiation tubes is installed inside the high-speed jet device, so as to realize the hot air generated in the annealing furnace body, resulting in a compact combined heating device. This reduces the heat dissipation area and improves the overall thermal efficiency of the equipment.

### Advantages of the Invention

The jet and radiation combined heating technology of the present invention combines jet heating and radiation tube heating, leveraging the technological advantages of both. The heat generated by the combustion of the radiation tubes is quickly transferred to the steel strip, achieving rapid steel strip heating.

For example, conventional radiation tubes in continuous annealing furnaces typically provide a heat flux density per unit area of the steel strip is of 20 kW when heating a 100° C. steel strip. Using the combined jet and radiation heating technology, the heat flux density per unit area of the steel strip reaches approximately 100 kW. This allows significant shortening of furnace length, reducing investment costs. As the heat generated by the combustion of the radiation tubes is carried away by the circulating gas in the bellows, reducing the exhaust temperature of the radiation tubes, improving thermal efficiency and reducing average operating temperature of radiation tubes, thereby extending tube lifespan. In addition, the temperature of the circulating gas that is heated again is more uniform, so the temperature distribution in the steel strip width direction during the heating process is more uniform, stabilizing unit operation.

The jet and radiation combined heating technology heats the steel strip via jet convection and radiation. It significantly increases the heating rate of steel stripe and rapidly transfers heat from radiation tube combustion to the steel strip through forced convection and radiation, achieving accelerated heating of steel strip. For equivalent production capacity, the number of heating passes is reduced from over a dozen to 2-3 passes, saving equipment footprint.

Since heat from combustion gases in the radiation tubes is rapidly removed by circulating gas, the radiation tube wall temperature decreases, lowering exhaust temperature of radiation tubes. The shortened furnace length (from over a dozen passes to 2-3 passes) reduces heat loss through the furnace casing, further improving radiation tube's thermal efficiency and energy utilization. This not only reduces operating costs and ton-steel production costs but also achieves energy savings, carbon reduction, and enhanced corporate competitiveness.

Using jet and radiation combined heating, steel strip heating combines radiant heating and circulating gas jet heating. The uniform gas temperature and the ease of controlling edge effects with jet heating ensure superior temperature uniformity across the steel strip width. This facilitates stable high-temperature steel strip passage and significantly improves surface quality.

The jet and radiation combined heating technology achieves a heating rate 4-5 times faster than conventional radiation tube furnaces. For a 1 mm-thick steel strip, the average heating rate within the 0-600° C. range reaches 40-50° C./s, meeting the annealing requirements for high-quality automotive exterior panels, home appliances board, and ultra-high-strength steels.

The high-speed jet and radiation combined rapid heating method of the present invention couples high-speed jets, increasing heating rate by 4-5 times compared to radiation tube furnaces. The improved jet temperature uniformity elevates steel strip heating uniformity from ±15° C. to ±5° C. In low-carbon metallurgy, radiation tube heat is transferred to the steel strip by forced jet, drastically reducing thermal resistance between them. Operational data shows an approximately 100° C. decrease in radiation tube exhaust temperature and an approximately 5% improvement in thermal efficiency under the same circumstances. With industrial gas utilization thermal efficiency at 50%, this method achieves 10% carbon reduction. Additionally, abandoning the jet-gas cushion function emphasized in non-ferrous metal rapid heating methods, the invention uses high-speed nozzles to increase convective heat transfer coefficients from 120 w/m²k to 200 w/m²k. Coupled with radiant heating, the overall heating rate doubles compared to pure jet heating.

### BRIEF DESCRIPTIONS OF THE DRAWINGS

FIG. 1: structural schematic 1 of an embodiment of the present invention;

FIG. 2: structural schematic 2 of an embodiment of the present invention;

FIG. 3: structural schematic of the jet bellow of an embodiment of the present invention;

FIG. 4: structural schematic of the radiation tube of an embodiment of the present invention.

### DESCRIPTIONS OF EMBODIMENTS

The present invention is further elucidated through embodiments and accompanying drawings. The embodiments merely exemplify one implementation form of the method of the invention, which is not limited thereto. Other implementation forms employing the method of the invention also fall within the scope of protection.

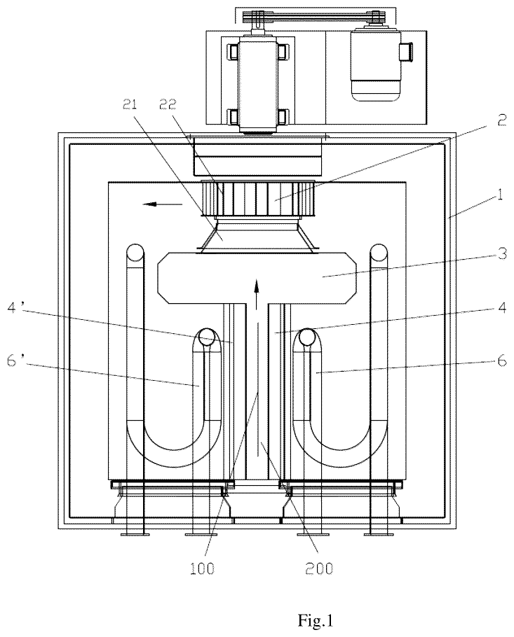

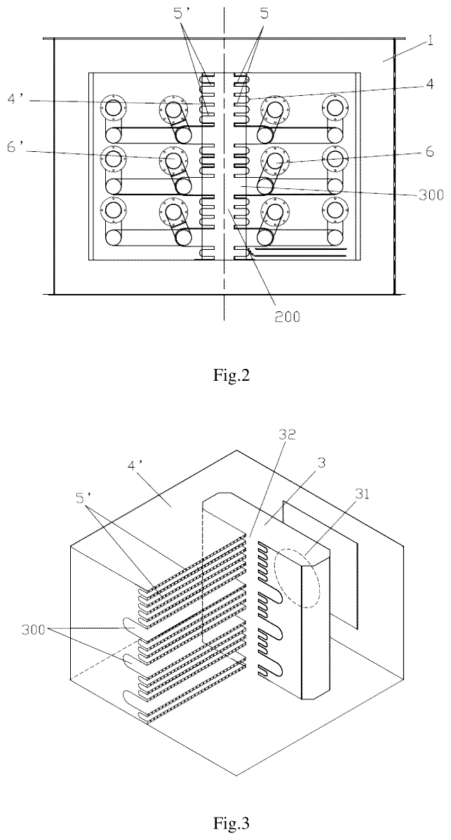

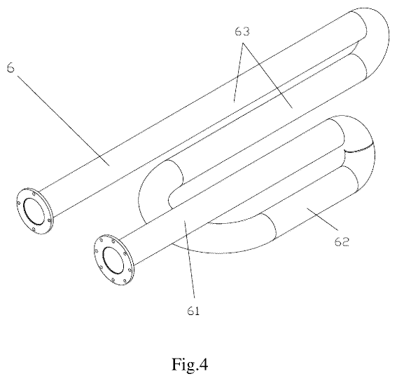

Referring to FIGS. 1-4, the high-speed jet and radiation combined heating device of the present invention comprises:

Heat-preservation box body 1, having thermal insulation material inside its casing, with a mounting hole being formed in the center of one side surface thereof.

Circulation fan 2, arranged at the mounting hole of the heat-preservation box body 1. Its air inlet 21 corresponding to the axis of the mounting hole, and its air outlet 22 is located on a side surface of a casing of the fan casing.

Buffering chamber 3, arranged in the heat-preservation box body 1 at a position corresponding to an air inlet 21 of the circulating fan 2, the back side of the buffering chamber 3 is provided with a hot air outlet 31 corresponding to the air inlet 21 of the circulating fan 2, and a hot air inlet 32 being formed in the front side of the buffering chamber 3.

Two jet bellows 4, 4′, vertically and symmetrically arranged on the two sides of the hot air inlet 32 at the front side of the buffering chamber 3 in the heat-preservation box body 1, forming a passage 200 for steel strip 100. on one side of the two jet bellows4, 4′ located on both sides of the passage 200, a plurality of rows of high-speed jet nozzles5, 5′ are spaced along the height direction, with a gap 300 provided between every of n rows of nozzles5, 5′, wherein n≥1.

A plurality of radiation tubes 6, 6′, symmetrically arranged in the two jet bellows 4, 4′, and each radiation tube 6 (taking tube 6 as representative) comprises a connection tube section 61 connected to the nozzles, a radiation tube section 62 bending and extending from one end of the connection tube section 61, and a heat exchange tube section 63 formed by bending and extending from one end of the radiation tube section, exchange tube section 63 is configured to be connected to an exhaust passage. The radiation tube section 62 corresponds to the gap300 between n rows of high-speed jet nozzles 5, 5′ in the jet bellows4, 4′, forming an alternating jet-and-radiation structure.

In this embodiment, the gap 300 between n rows of jet nozzles 5, 5′ in the jet bellows 4, 4′ is configured as a U-shaped structure. The radiation tube section 62 of the radiation tube 6 is embedded within this U-shaped structure.

Preferably, the buffering chamber 3 and jet bellows 4, 4′ are of an integrated structure.

Preferably, the high-speed jet nozzles 5, 5′ are of a circular-hole structure.

Preferably, the diameter of the nozzles is 1/10 to ⅕ of the distance between the nozzles and the steel strip.

Preferably, the radiation tube section 62, the connection tube section 61, and the heat exchange tube section 63 are arranged in parallel.

The high-speed jet and radiation combined heating device and rapid heating method thereof adopted in the present invention, the radiation tubes is connected to the nozzles via the connection tube section, combustion gases within the radiation tube fully burn, radiant heating to the steel strip entering the passage through the radiation tube section; simultaneously, the heat exchange tube section heats the gas pressurized by the circulating fan and entering the heat-preservation box body, the heated air enter the jet bellows, heating the steel strip through jet by the high-speed jet nozzles, wherein the hot air after heated the steel strip, after being pressurized by the circulating fan, re-enters the heat-preservation box body through the air outlet of the circulating fan, and is heated by the heat exchange tube section of the radiation tubes, thereby completing the cycle.

The application of the high-speed jet and radiation combined heating technology described in the present invention significantly enhances the production capacity of existing units, resolving insufficient heating capability in production lines. This technology rapidly transfers heat from combustion gases in the radiation tube to the steel strip via forced heat exchange, achieving rapid strip heating, this allows substantial reduction in heating furnace length and lowers the thermal inertia of the furnace body. Since the heat generated by combustion gases in the radiation tube is carried away by circulating gas in the jet bellows, it not only reduces the exhaust temperature of the radiation tube, improving its thermal efficiency, but also lowers the average operating temperature of the radiation tube, extending its service life. The heated circulating gas exhibits uniform temperature distribution, resulting in the temperature distribution in the width direction of the strip is more uniform during the heating process, thereby enhancing operational stability of the unit. This technology holds broad prospects for widespread application.

The described examples are illustrative and non-restrictive. Variations adhering to the invention's principles fall within its scope.

1. A jet and radiation combined heating device, comprising:
a heat-preservation box body, a mounting hole being formed in the center of one side surface thereof;
a circulating fan, arranged at the mounting hole of the heat-preservation box body, with an air inlet corresponding to an axis of the mounting hole, and an air outlet provided on a side surface of a casing;
a buffering chamber, arranged in the heat-preservation box body at a position corresponding to the air inlet of the circulating fan, a back side of the buffering chamber is provided with a hot air outlet corresponding to the air inlet of the circulating fan, and a hot air inlet being formed in a front side of the buffering chamber;
two jet bellows, vertically and symmetrically arranged on two sides of the hot air inlet at the front side of the buffering chamber in the heat-preservation box body, forming a passage for steel strip; on one side surface of the two jet bellows located on both sides of the passage, a plurality of rows of nozzles are spaced along a height direction, with a gap provided between every of n rows of nozzles, wherein n≥1;
a plurality of radiation tubes, symmetrically arranged in the two jet bellows, the radiation tube comprising a connection tube section connected to the nozzle, a radiation tube section bending and extending from one end of the connection tube section, and a heat exchange tube section formed by bending and extending from one end of the radiation tube section, the radiation tube section corresponding to the gap between n rows of high-speed jet nozzles in the jet bellows, forming an alternating jet-and-radiation structure.

2. The jet and radiation combined heating device according to claim 1, wherein:
the buffering chamber and the jet bellows are of an integrated structure.

3. The jet and radiation combined heating device according to claim 1, wherein:
the nozzles are of a circular-hole structure.

4. The jet and radiation combined heating device according to claim 1, wherein:
the diameter of the nozzles is 1/10 to ⅕ of the distance between the nozzles and the steel strip.

5. The jet and radiation combined heating device according to claim 1, wherein:
the radiation tube section, the connection tube section, and the heat exchange tube section are arranged in parallel.

6. The jet and radiation combined heating device according to claim 1, wherein:
the heat-preservation box body contains thermal insulation material within its casing.

7. The jet and radiation combined heating device according to claim 1, wherein:
the gap is of an U-shaped structure, and the radiation tube section embedded within the U-shaped structure.

8. The jet and radiation combined heating device according to claim 1, wherein:
the nozzles are high-speed jet nozzles.

9. The jet and radiation combined heating device according to claim 1, wherein:
the jet bellows are high-temperature jet bellows.

10. A rapid heating method using the jet and radiation combined heating device according to claim 1.

11. The rapid heating method according to claim 10, comprising:
ensuring a complete combustion of a combustion gas within the radiation tubes of the jet and radiation combined heating device, performing radiantly heating on the steel strip entering the passage through the radiation tube section;
simultaneously, using the heat exchange tube section to heat the gas entering the heat-preservation box body after being pressurized by the circulating fan, and causing the heated air to enter the jet bellows, heating the steel strip through a nozzle jet, wherein the hot air after heated the steel strip, after being pressurized by the circulating fan, re-enters the heat-preservation box body through the air outlet of the circulating fan, and is heated by the heat exchange tube section of the radiation tubes, thereby completing a cycle.

12. The rapid heating method according to claim 11, wherein:
the gas for jetting the steel strip is N₂+H₂.

13. The rapid heating method according to claim 10, wherein:
when the jet heating the steel strip, the heat flux density per unit area of the steel strip is ≥50 kW.

14. The rapid heating method according to claim 10, wherein:
an average heating rate of the method in the range of 0-600° C. is 30° C./s-50° C./s.

15. The jet and radiation combined heating device according to claim 3, wherein the diameter of the nozzles is 1/10 to ⅕ of the distance between the nozzles and the steel strip.

16. The jet and radiation combined heating device according to claim 8, wherein the velocity of the jet gas at nozzle outlet of is not less than 50 m/s.

17. The jet and radiation combined heating device according to claim 9, wherein the temperature of high-temperature gas in the high-temperature jet bellows is above 750° C.

18. The jet and radiation combined heating device according to claim 17, wherein the temperature of high-temperature gas in the high-temperature jet bellows is 750° C.˜880° C.

19. The rapid heating method according to claim 10, wherein in the jet and radiation combined heating device:
the buffering chamber and the jet bellows are of an integrated structure;
the nozzles are of a circular-hole structure;
the diameter of the nozzles is 1/10 to ⅕ of the distance between the nozzles and the steel strip;
the radiation tube section, the connection tube section, and the heat exchange tube section are arranged in parallel;
the heat-preservation box body contains thermal insulation material within its casing; and/or
the gap is of an U-shaped structure, and the radiation tube section embedded within the U-shaped structure;

20. The rapid heating method according to claim 10, wherein:
the velocity of the jet gas at nozzle outlet of is not less than 50 m/s; and/or
the temperature of high-temperature gas in the high-temperature jet bellows is above 750° C.
